(19) United States
(12) Patent Application Publication
(10) Pub. No.: US 2023/0129110 A1
(43) Pub. Date: Apr. 27, 2023

(54) MAGNETIC TAPE DEVICE, METHOD OF OPERATING MAGNETIC TAPE DEVICE, AND MAGNETIC TAPE

(71) Applicant: FUJIFILM CORPORATION, Tokyo (JP)

(72) Inventors: Toru NAKAO, Kanagawa (JP); Ren ISHIKAWA, Kanagawa (JP)

(21) Appl. No.: 18/145,821

(22) Filed: Dec. 22, 2022

Related U.S. Application Data
(63) Continuation of application No. PCT/JP2021/015581, filed on Apr. 15, 2021.

(30) Foreign Application Priority Data
Jul. 20, 2020 (JP) 2020-123829

(51) Int. Cl. G11B 5/008; G11B 25/08

(52) U.S. Cl. CPC G11B 5/0086; G11B 25/08

(57) ABSTRACT

Provided is a magnetic tape device including: a magnetic head having a magnetic element that acts on a magnetic layer formed on a front surface of a magnetic tape; and a guide member that is disposed at a position facing the magnetic head via the magnetic tape and guides the magnetic tape to the magnetic head, in which a back surface of the magnetic tape, which is provided on a side opposite to the front surface and is a surface coarser than the front surface, is slid on the guide member.

### CROSS-REFERENCE TO RELATED APPLICATIONS

This application is a continuation application of International Application No. PCT/JP2021/015581 filed on Apr. 15, 2021, the disclosure of which is incorporated herein by reference in its entirety. Further, this application claims priority from Japanese Patent Application No. 2020-123829 filed on Jul. 20, 2020, the disclosure of which is incorporated herein by reference in its entirety.

### BACKGROUND

### 1. Technical Field

The technology of the present disclosure relates to a magnetic tape device, a method of operating a magnetic tape device, and a magnetic tape.

### 2. Description of the Related Art

JP2006-127730A discloses a magnetic tape device comprising a magnetic head on which a front surface of a magnetic tape having a magnetic layer formed thereon is slid. U.S. Pat. No. 8,054,582B discloses a magnetic tape device in which air is blown from an air blowing member onto a back surface of a magnetic tape provided on a side opposite to a front surface, and the magnetic tape is brought to face a magnetic head in a state of being floated by the air.

### SUMMARY

In recent years, magnetic tapes have been required to improve front surface smoothness of a magnetic layer in order to increase recording density. For this reason, in JP2006-127730A, a contact area between the front surface of the magnetic tape on which the magnetic layer is formed and a sliding surface of the magnetic head is increased, and friction between the magnetic tape and the sliding surface of the magnetic head is increased. As a result, the magnetic layer is scratched or the magnetic tape is displaced from a regular running position in a width direction because of vibration caused by the friction.

In U.S. Pat. No. 8,054,582B, the problem of friction between the magnetic tape and the sliding surface of the magnetic head as in JP2006-127730A does not occur in the first place because the magnetic tape is floated by air. However, since the magnetic tape in a state of being floated by air is not supported, the magnetic tape is easily displaced from the regular running position in the width direction because of speed variation and/or tension variation during running. In addition, the magnetic tape vibrates because of the air passing between the magnetic tape and the air blowing member, and this vibration also causes the magnetic tape to be displaced from the regular running position in the width direction. As described above, even in U.S. Pat. No. 8,054,582B, the magnetic tape is displaced from the regular running position in the width direction for a reason other than the friction between the magnetic tape and the sliding surface of the magnetic head in the case of JP2006-127730A.

In addition, in order to suppress the displacement of the magnetic tape from the regular running position in the width direction, a method of pressing restriction guide members, such as leaf springs, against both ends of the magnetic tape in the width direction is conceivable for the time being. However, in this case, another problem arises in which the restriction guide members damage both ends of the magnetic tape in the width direction.

One embodiment of the technology of the present disclosure provides a magnetic tape device, a method of operating a magnetic tape device, and a magnetic tape capable of effectively suppressing a displacement of the magnetic tape from a regular running position in a width direction.

According to the present disclosure, there is provided a magnetic tape device comprising: a magnetic head having a magnetic element that acts on a magnetic layer formed on a front surface of a magnetic tape; and a guide member that is disposed at a position facing the magnetic head via the magnetic tape and guides the magnetic tape to the magnetic head, in which a back surface of the magnetic tape, which is provided on a side opposite to the front surface and is a surface coarser than the front surface, is slid on the guide member.

It is preferable that a width of the magnetic head is smaller than a width of the magnetic tape.

It is preferable that a width of the guide member is larger than a width of the magnetic tape.

It is preferable that a sliding surface of the guide member on which the back surface is slid has a groove formed along a width direction of the magnetic tape.

It is preferable that the magnetic head is disposed at a position facing the groove via the magnetic tape.

It is preferable that the magnetic head includes a feed head that operates in a case where the magnetic tape is fed out from a feed reel on which the magnetic tape is wound, and a rewind head that operates in a case where the magnetic tape is rewound on the feed reel.

It is preferable that the feed head takes charge of a first region divided with respect to a width direction of the magnetic tape, and the rewind head takes charge of a second region divided with respect to the width direction.

It is preferable that a servo pattern used for servo control to move the magnetic head in a width direction of the magnetic tape is recorded on the magnetic layer, and the magnetic head has a servo pattern reading element that reads the servo pattern, as the magnetic element.

It is preferable that a plurality of servo bands on which the servo pattern is recorded and a plurality of data bands on which data is recorded are alternately arranged in the magnetic layer along the width direction of the magnetic tape, and the magnetic heads are provided as many as the number of data bands.

It is preferable that the magnetic head has, as the magnetic element, two servo pattern reading elements corresponding to two servo bands that sandwich one data band, and a data element provided between two servo pattern reading elements.

It is preferable that the data element includes a data recording element that records the data on the magnetic layer, and a data reading element that reads the data recorded on the magnetic layer.

According to the present disclosure, there is provided a magnetic tape used for the magnetic tape device according to any one of the above.

According to the present disclosure, there is provided a method of operating a magnetic tape device, comprising: sliding, on a guide member disposed at a position facing a magnetic head via a magnetic tape, a back surface of the magnetic tape provided on a side opposite to a front surface on which a magnetic layer is formed, the back surface being a surface coarser than the front surface; and causing a magnetic element of the magnetic head to act on the magnetic layer of the magnetic tape guided by the guide member.

According to the technology of the present disclosure, it is possible to provide a magnetic tape device, a method of operating a magnetic tape device, and a magnetic tape capable of effectively suppressing a displacement of the magnetic tape from a regular running position in a width direction.

### BRIEF DESCRIPTION OF THE DRAWINGS

Exemplary embodiments according to the technique of the present disclosure will be described in detail based on the following figures, wherein:

FIG. 1 is a diagram showing an example of a magnetic tape device;

FIG. 2 is an enlarged view of a vicinity of a guide member;

FIG. 3 is a plan view of a guide member as viewed from sides of a feed head and of a rewind head;

FIG. 4 is an enlarged view of a vicinity of the feed head;

FIG. 5 is a diagram showing a correspondence relationship between a data element and a data track;

FIG. 6 is an enlarged view of the data element;

FIG. 7 is a block diagram of a control unit;

FIG. 8 is a flowchart showing an operation procedure of the magnetic tape device;

FIG. 9 is a diagram showing a guide member in which a cavity is formed;

FIG. 10 is a diagram showing an aspect in which the feed head and the rewind head are disposed at positions facing a slit of a guide member via the magnetic tape; and

FIG. 11 is a diagram showing another example of the magnetic tape, the feed head, and the rewind head.

### DETAILED DESCRIPTION

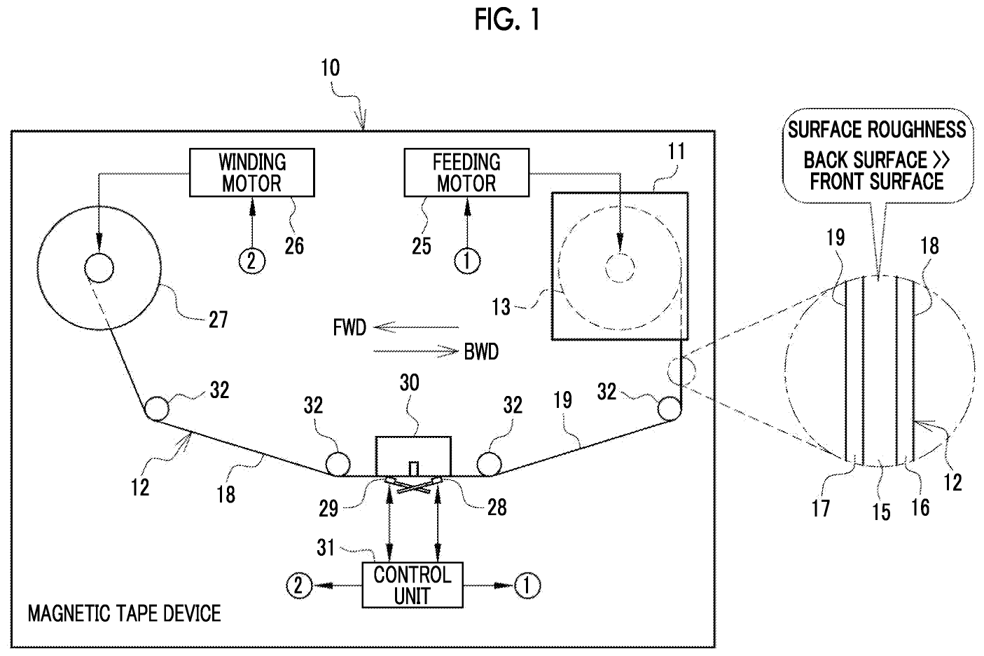

In FIG. 1, a cartridge 11 is loaded into a magnetic tape device 10. A cartridge reel 13 on which a magnetic tape 12 is wound is accommodated in the cartridge 11. The magnetic tape device 10 records data on the magnetic tape 12 fed out from the cartridge reel 13. Further, the magnetic tape device 10 reads data recorded on the magnetic tape 12. The cartridge reel 13 is an example of the “feed reel” according to the technology of the present disclosure.

The magnetic tape 12 has, for example, a configuration in which a magnetic layer 16 and a back coating layer 17 are formed on a base film 15. Data is recorded on the magnetic layer 16. The magnetic layer 16 contains ferromagnetic powder. As the ferromagnetic powder, ferromagnetic powder generally used in the magnetic layer of various magnetic recording media can be used. Preferable specific examples of the ferromagnetic powder can include hexagonal ferrite powder. As the hexagonal ferrite powder, for example, hexagonal strontium ferrite powder or hexagonal barium ferrite powder can be used. The back coating layer 17 contains, for example, non-magnetic powder, such as carbon black. The base film 15 is also called a support and is formed of, for example, polyethylene terephthalate, polyethylene naphthalate, or polyamide. A non-magnetic layer may be formed between the base film 15 and the magnetic layer 16.

In the magnetic tape 12, a surface on which the magnetic layer 16 is formed is a front surface 18 of the magnetic tape 12. On the other hand, a surface on which the back coating layer 17 is formed is a back surface 19 of the magnetic tape 12. The magnetic layer 16 is required to improve front surface smoothness in order to increase the recording density. On the other hand, the back coating layer 17 is not restricted like the magnetic layer 16. Therefore, the back surface 19 is a surface coarser than the front surface 18.

The magnetic tape device 10 comprises a feeding motor 25, a winding motor 26, a winding reel 27, a feed head 28, a rewind head 29, a guide member 30, a control unit 31, and the like. The feed head 28 and the rewind head 29 are an example of the “magnetic head” according to the technology of the present disclosure. Hereinafter, the feed head 28 and the rewind head 29 may be collectively denoted as a magnetic head.

The feeding motor 25 rotates the cartridge reel 13 provided in the cartridge 11 under the control of the control unit 31. The magnetic tape 12 fed out from the cartridge reel 13 is wound on the winding reel 27. Further, the magnetic tape 12 wound up on the winding reel 27 is rewound on the cartridge reel 13. The winding motor 26 rotates the winding reel 27 under the control of the control unit 31.

The magnetic tape 12 runs in a feed direction FWD or a rewind direction BWD while being guided by a plurality of guide rollers 32 with the drive of the feeding motor 25 and the winding motor 26. The feed direction FWD is a direction from the cartridge reel 13 toward the winding reel 27. The rewind direction BWD is, on the contrary, a direction from the winding reel 27 toward the cartridge reel 13. Further, in the magnetic tape 12, the rotational speed and the rotational torque of the feeding motor 25 and the winding motor 26 are adjusted so that the tension during running and the running speed are adjusted to appropriate values.

The feed head 28 and the rewind head 29 are disposed on the front surface 18 side of the magnetic tape 12 in order to access the magnetic layer 16. The feed head 28 and the rewind head 29 record data on the magnetic layer 16. Further, the feed head 28 and the rewind head 29 read data recorded on the magnetic layer 16.

The feed head 28 operates in a case where the magnetic tape 12 is running in the feed direction FWD. In other words, the feed head 28 operates in a case where the magnetic tape 12 is fed out from the cartridge reel 13. On the other hand, the rewind head 29 operates in a case where the magnetic tape 12 is running in the rewind direction BWD. In other words, the rewind head 29 operates in a case where the magnetic tape 12 is rewound on the cartridge reel 13.

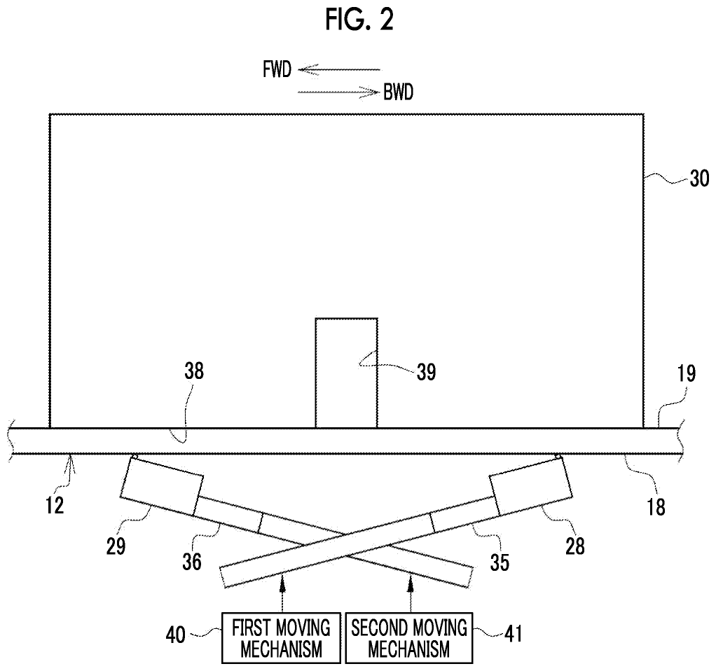

The feed head 28 and the rewind head 29 have the same structure except that operating timings are different from each other. The feed head 28 and the rewind head 29 are small magnetic heads, such as a magnetic head used for a hard disk drive. The feed head 28 and the rewind head 29 are provided at distal ends of suspensions 35 and 36 (see FIG. 2 and the like), respectively. Proximal ends of the suspensions 35 and 36 are movably attached to a frame of the magnetic tape device 10 via, for example, an arm. The feed head 28 and the rewind head 29 may be retracted to a standby position separated from the magnetic tape 12 during non-operation.

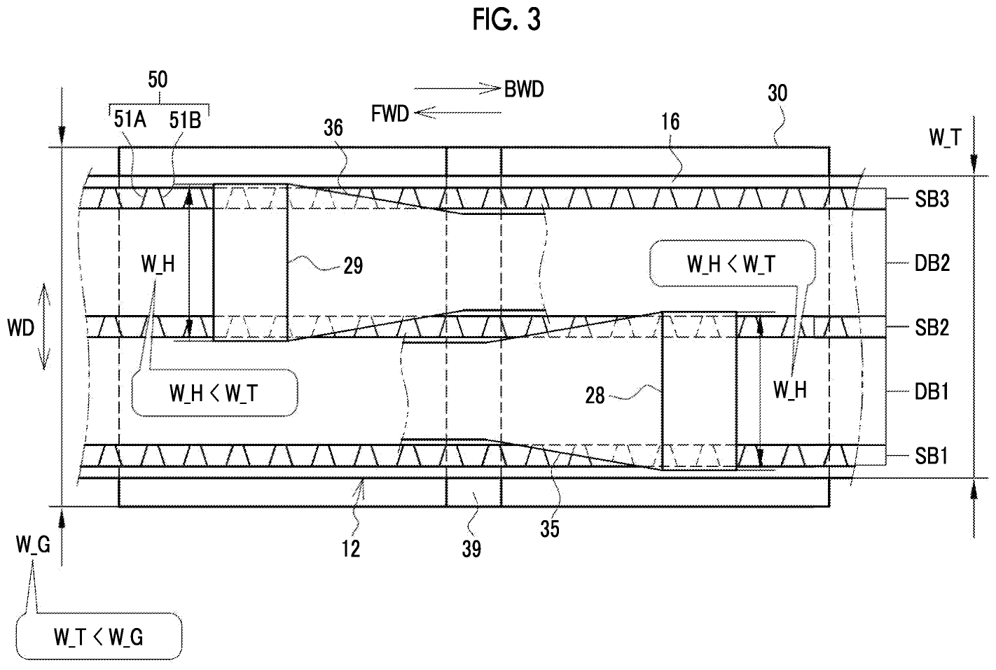

The guide member 30 has a rectangular shape (see also FIG. 3) and is disposed on the back surface 19 side of the magnetic tape 12 facing the feed head 28 and the rewind head 29. The guide member 30 guides the magnetic tape 12 to the feed head 28 and the rewind head 29.

As shown in the enlarged view of FIG. 2, the guide member 30 has a flat sliding surface 38. The back surface 19 of the magnetic tape 12 is slid on the sliding surface 38. That is, the magnetic tape 12 runs while sliding the back surface 19 on the sliding surface 38. The magnetic tape 12 runs such that the center of a width direction WD (see FIG. 3 and the like, a direction perpendicular to a paper surface in FIG. 2) thereof coincides with the center of the guide member 30. The feed head 28 and the rewind head 29 are disposed at positions facing the sliding surface 38 via the magnetic tape 12. The term “coincide” as used herein indicates a coincidence in a sense including an error generally allowed in the technical field to which the technology of the present disclosure belongs, in addition to the complete coincidence.

A slit 39 is formed in a central part of the sliding surface 38. The slit 39 is a groove that reaches both side surfaces of the guide member 30 facing each other in the width direction WD of the magnetic tape 12. That is, the slit 39 is an example of the “groove” according to the technology of the present disclosure.

A first moving mechanism 40 is connected to the suspension 35, and a second moving mechanism 41 is connected to the suspension 36. The first moving mechanism 40 moves the suspension 35, that is, the feed head 28, in the width direction WD of the magnetic tape 12. Similarly, the second moving mechanism 41 also moves the suspension 36, that is, the rewind head 29, in the width direction WD of the magnetic tape 12. The first moving mechanism 40 and the second moving mechanism 41 each include, for example, an actuator, such as a voice coil motor or a piezoelectric element.

In FIG. 3 in which the guide member 30 is viewed from the sides of the feed head 28 and of the rewind head 29, the feed head 28 and the rewind head 29 are disposed so as to be shifted from each other in the feed direction FWD and the rewind direction BWD (a length direction of the magnetic tape 12) such that the feed head 28 and the rewind head 29 do not interfere with each other. A width W_H of each of the feed head 28 and the rewind head 29 is smaller than a width W_T of the magnetic tape 12. Specifically, the width W_H of each of the feed head 28 and the rewind head 29 is about ½ of the width W_T of the magnetic tape 12. The width W_T of the magnetic tape 12 is, for example, 12.65 mm, and the width W_H of each of the feed head 28 and the rewind head 29 is, for example, 6.5 mm to 7.0 mm. Incidentally, other sizes such as the depth and the height of each of the feed head 28 and the rewind head 29 are also smaller than the width W_T of the magnetic tape 12 and are, for example, about several mm. Further, a width W_G of the guide member 30 is larger than the width W_T of the magnetic tape 12.

The magnetic layer 16 has three servo bands SB1, SB2, and SB3 and two data bands DB1 and DB2 on which data is recorded. These servo bands SB1 to SB3 and these data bands DB1 and DB2 are formed along the feed direction FWD and the rewind direction BWD. The servo bands SB1 to SB3 are arranged at equal intervals along the width direction WD of the magnetic tape 12. The data band DB1 is disposed between the servo bands SB1 and SB2, and the data band DB2 is disposed between the servo bands SB2 and SB3. That is, the servo bands SB1 to SB3 and the data bands DB1 and DB2 are alternately arranged along the width direction WD of the magnetic tape 12.

A servo pattern 50 is recorded on the servo bands SB1 to SB3. A plurality of the servo patterns 50 are provided at equal intervals along, for example, the feed direction FWD and the rewind direction BWD. The servo pattern 50 is composed of a pair of linearly symmetric magnetization regions 51A and 51B that are non-parallel to each other and that form a predetermined angle. The magnetization region 51A is tilted toward the rewind direction BWD side, and the magnetization region 51B is tilted toward the feed direction FWD side. The servo pattern 50 is used for the servo control to move the feed head 28 and the rewind head 29 in the width direction WD of the magnetic tape 12 through the first moving mechanism 40 and the second moving mechanism 41.

The feed head 28 records data on the data band DB1 and reads data recorded on the data band DB1. Further, the feed head 28 reads the servo patterns 50 recorded on the servo bands SB1 and SB2. In other words, the feed head 28 takes charge of a first region divided with respect to the width direction WD of the magnetic tape 12. The first region in this case is the servo bands SB1 and SB2 and the data band DB1.

Meanwhile, the rewind head 29 records data on the data band DB2 and reads data recorded on the data band DB2. Further, the rewind head 29 reads the servo patterns 50 recorded on the servo bands SB2 and SB3. In other words, the rewind head 29 takes charge of a second region divided with respect to the width direction WD of the magnetic tape 12. The second region in this case is the servo bands SB2 and SB3 and the data band DB2.

In this way, the feed head 28 is in charge of recording data on the data band DB1 and reading data recorded on the data band DB1. Further, the rewind head 29 is in charge of recording data on the data band DB2 and reading data recorded on the data band DB2. That is, two magnetic heads are provided in just proportion for two data bands DB1 and DB2.

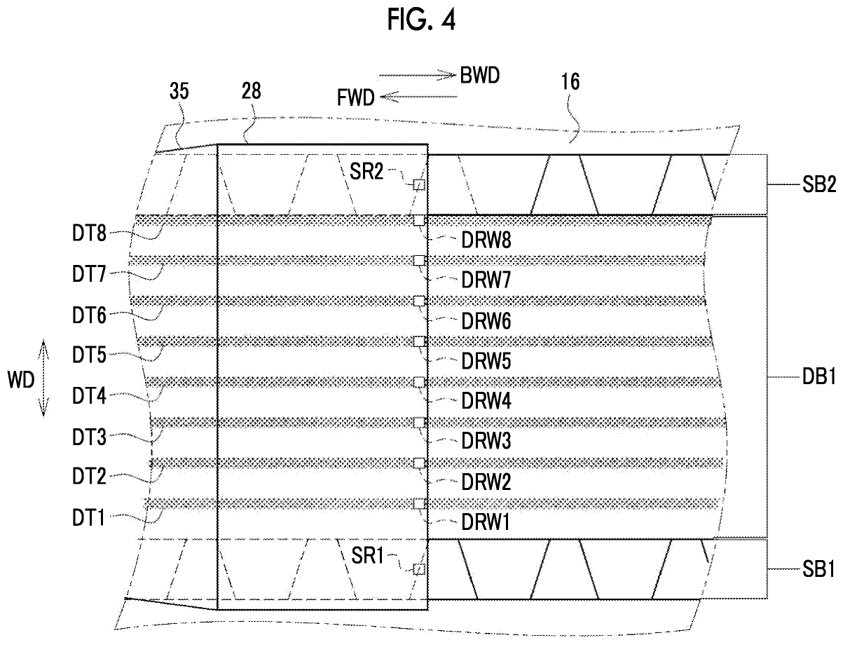

In FIG. 4, which is an enlarged view of the vicinity of the feed head 28, the feed head 28 has a plurality of magnetic elements that are provided on a surface facing the magnetic layer 16 and that act on the magnetic layer 16. The feed head 28 causes the magnetic element to act on the magnetic layer 16 by bringing the magnetic element into contact with or close to the magnetic layer 16. The term “close” as used herein means that the gap between the magnetic layer 16 and the magnetic element, which is called a spacing, is maintained on, for example, the order of several nm.

The magnetic element has two servo pattern reading elements SR1 and SR2, and eight data elements DRW1, DRW2, DRW3, DRW4, DRW5, DRW6, DRW7, and DRW8. Hereinafter, in a case where there is no need to make a particular distinction, the servo pattern reading elements SR1 and SR2 are collectively denoted as a servo pattern reading element SR, and the data elements DRW1 to DRW8 are collectively denoted as a data element DRW.

The servo pattern reading element SR1 is provided at a position corresponding to the servo band SB1, and the servo pattern reading element SR2 is provided at a position corresponding to the servo band SB2. The data elements DRW1 to DRW8 are provided between the servo pattern reading elements SR1 and SR2. The data elements DRW1 to DRW8 are arranged at equal intervals along the width direction WD of the magnetic tape 12. The data elements DRW1 to DRW8 simultaneously record data and/or read data with respect to eight data tracks DT1, DT2, DT3, DT4, DT5, DT6, DT7, and DT8.

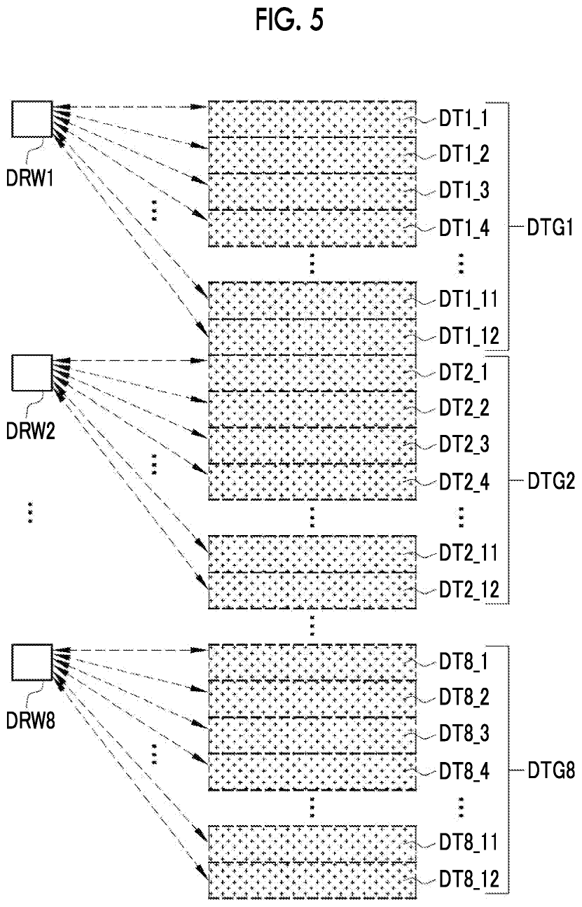

As shown in FIG. 5 as an example, the data element DRW1 is in charge of recording data on a data track group DTG1 composed of a total of 12 data tracks DT, that is, data tracks DT1_1, DT1_2, DT1_3, DT1_4, . . . , DT1_11, and DT1_12. In addition, the data element DRW1 is in charge of reading data recorded on the data track group DTG1. Similarly, the data element DRW2 is in charge of recording data on a data track group DTG2, which is composed of data tracks DT2_1 to DT2_12, and of reading data recorded on the data track group DTG2. Hereinafter, similarly, the data element DRW8 is in charge of recording data on a data track group DTG8, which is composed of data tracks DT8_1 to DT8_12, and of reading data recorded on the data track group DTG8. Twelve data tracks DT constituting each of the data track groups DTG1 to DTG8 are arranged at equal intervals along the width direction WD of the magnetic tape 12. The number of data tracks DT included in one data band DB is 8×12=96. In a case where there is no need to make a particular distinction, the data tracks DT1 to DT8 are collectively denoted as a data track DT.

The data element DRW is shifted to a position corresponding to one designated data track DT out of 12 data tracks with the movement of the feed head 28 in the width direction WD performed by the first moving mechanism 40. The data element DRW stays at a position corresponding to one designated data track DT through the servo control using the servo pattern 50.

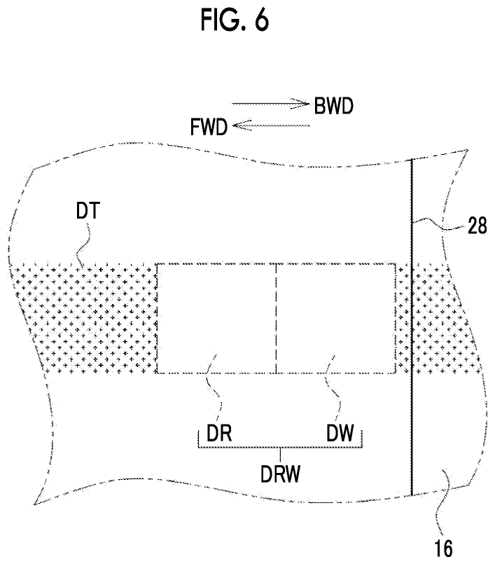

As shown in the enlarged view of FIG. 6, the data element DRW includes a data recording element DW and a data reading element DR. The data recording element DW records data on the data track DT. The data reading element DR reads the data recorded on the data track DT.

The data recording element DW is disposed on an upstream side of the feed direction FWD, and the data reading element DR is disposed on a downstream side of the feed direction FWD. The reason for such a disposition is that the data reading element DR immediately reads the data recorded by the data recording element DW to check errors.

Although neither shown nor described in detail, the rewind head 29 also has two servo pattern reading elements SR corresponding to the servo bands SB2 and SB3 and eight data elements DRW provided between two servo pattern reading elements SR. The data element DRW of the rewind head 29 performs data recording and/or data reading with respect to 96 data tracks DT of the data band DB2. The data element DRW of the rewind head 29 includes a data recording element DW disposed on an upstream side of the rewind direction BWD and a data reading element DR disposed on a downstream side of the rewind direction BWD.

The control unit 31 is realized by, for example, a computer including a central processing unit (CPU), a memory, and a storage. The memory is, for example, a random access memory (RAM) or the like and temporarily stores various types of information. The storage, which is a non-transitory storage medium, is, for example, a hard disk drive or a solid state drive and stores various parameters and various programs. The CPU loads the program stored in the storage into the memory and executes processing in accordance with the program, thereby controlling the operation of each unit of the magnetic tape device 10 in an integrated manner.

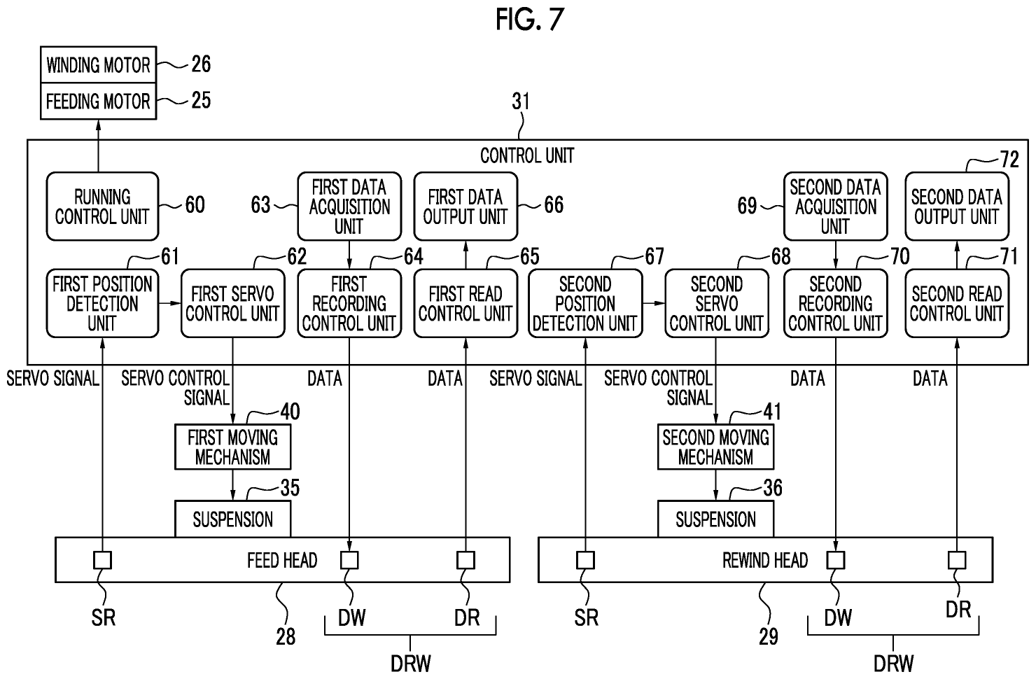

In FIG. 7, the control unit 31 functions as a running control unit 60, a first position detection unit 61, a first servo control unit 62, a first data acquisition unit 63, a first recording control unit 64, a first read control unit 65, a first data output unit 66, a second position detection unit 67, a second servo control unit 68, a second data acquisition unit 69, a second recording control unit 70, a second read control unit 71, and a second data output unit 72.

The running control unit 60 controls the drive of the feeding motor 25 and the winding motor 26 to cause the magnetic tape 12 to run in the feed direction FWD or the rewind direction BWD. Further, the running control unit 60 adjusts the rotational speed and the rotational torque of the feeding motor 25 and the winding motor 26 to adjust the tension during running and the running speed of the magnetic tape 12 to appropriate values.

A servo signal based on the servo pattern 50 read by the servo pattern reading element SR of the feed head 28 is input to the first position detection unit 61. The servo signal is intermittent pulses corresponding to the magnetization regions 51A and 51B. The first position detection unit 61 detects the position of the servo pattern reading element SR in the servo band SB in the width direction WD, that is, the position of the feed head 28 in the width direction WD with respect to the magnetic tape 12, on the basis of a pulse interval of the servo signal. The first position detection unit 61 outputs the detection result of the position of the feed head 28 in the width direction WD to the first servo control unit 62.

Two types of servo signals based on the servo patterns 50 read by two servo pattern reading elements SR are input to the first position detection unit 61. The first position detection unit 61 calculates the average value of the pulse intervals of two types of servo signals. Then, the first position detection unit 61 detects the position of the feed head 28 in the width direction WD, on the basis of the calculated average value.

The first servo control unit 62 compares the detection result of the position of the feed head 28 from the first position detection unit 61 with a target position of the feed head 28. In a case where the detection result is the same as the target position, the first servo control unit 62 does nothing. In a case where the detection result is displaced from the target position, the first servo control unit 62 outputs a servo control signal for making the position of the feed head 28 match the target position, to the first moving mechanism 40. The first moving mechanism 40 operates so as to make the position of the feed head 28 match the target position according to the servo control signal. The target position is stored in the storage, for example, in the form of a data table in which the values corresponding to the respective data tracks DT1 to DT8 are registered.

The first data acquisition unit 63 reads out and acquires the data to be recorded on the data band DB1 by the feed head 28 from, for example, a host computer (not shown) connected to the magnetic tape device 10. The first data acquisition unit 63 outputs the data to the first recording control unit 64.

The first recording control unit 64 encodes the data output from the first data acquisition unit 63 into a digital signal for recording. Then, the first recording control unit 64 causes a pulse current corresponding to the digital signal to flow into the data recording element DW of the feed head 28, and causes the data recording element DW to record the data on the designated data track DT of the data band DB1.

The first read control unit 65 controls the operation of the data reading element DR of the feed head 28 to cause the data reading element DR to read the data recorded on the designated data track DT of the data band DB1. The data read by the data reading element DR is a pulse-shaped digital signal. The first read control unit 65 outputs this pulse-shaped digital signal to the first data output unit 66.

The first data output unit 66 decodes the pulse-shaped digital signal output from the first read control unit 65 to obtain data. The first data output unit 66 outputs the data to, for example, the host computer.

The second position detection unit 67, the second servo control unit 68, the second data acquisition unit 69, the second recording control unit 70, the second read control unit 71, and the second data output unit 72 have the same functions as the first position detection unit 61, the first servo control unit 62, the first data acquisition unit 63, the first recording control unit 64, the first read control unit 65, and the first data output unit 66, except that the above-described feed head 28 is replaced with the rewind head 29 and the data band DB1 is replaced with the data band DB2. Therefore, detailed description thereof will be omitted.

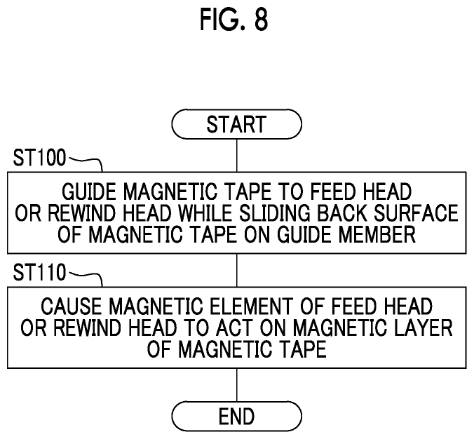

Hereinafter, the action of the above-described configuration will be described with reference to the flowchart of FIG. 8. First, the feeding motor 25 and the winding motor 26 are operated and cause the magnetic tape 12 to run in the feed direction FWD or the rewind direction BWD, under the control of the running control unit 60. With this, as shown in FIG. 2, the magnetic tape 12 is guided to the feed head 28 or the rewind head 29 while the back surface 19 of the magnetic tape 12 is slid on the sliding surface 38 of the guide member 30 disposed at a position facing the feed head 28 and the rewind head 29 (step ST100).

Then, the magnetic element of the feed head 28 or the rewind head 29 acts on the magnetic layer 16 of the magnetic tape 12 (step ST110). Specifically, the servo pattern 50 is read by the servo pattern reading element SR. Further, the data is recorded on the data track DT by the data recording element DW under the control of the first recording control unit 64 or the second recording control unit 70. Furthermore, the data recorded on the data track DT is read by the data reading element DR under the control of the first read control unit 65 or the second read control unit 71.

The first position detection unit 61 or the second position detection unit 67 detects the position of the feed head 28 in the width direction WD or the position of the rewind head 29 in the width direction WD, from the interval of the servo signals based on the servo patterns 50. The first servo control unit 62 or the second servo control unit 68 compares the detection result of the position of the first position detection unit 61 or the second position detection unit 67 with the target position, and performs the servo control for making the position of the feed head 28 or the rewind head 29 match the target position.

As described above, the magnetic tape device 10 comprises the feed head 28 and the rewind head 29 as magnetic heads, and the guide member 30. The feed head 28 and the rewind head 29 each have the magnetic element that acts on the magnetic layer 16 formed on the front surface 18 of the magnetic tape 12. The back surface 19 of the magnetic tape 12 provided on the side opposite to the front surface 18 is slid on the sliding surface 38 of the guide member 30. The back surface 19 is a surface coarser than the front surface 18. Therefore, the contact area between the magnetic tape 12 and the sliding surface 38 is reduced, and the friction between the magnetic tape 12 and the sliding surface 38 is reduced, as compared with a case where the front surface 18 is slid. Accordingly, it is possible to effectively suppress the displacement of the magnetic tape 12 from the regular running position in the width direction WD. In addition, scratches on the magnetic layer 16 can be reduced.

As shown in FIG. 3, the width W_H of each of the feed head 28 and the rewind head 29 is smaller than the width W_T of the magnetic tape 12. Since the weight is lighter than that of a magnetic head having a width W_H equal to or more than the width W_T, the response speed of the movement in the width direction WD in the servo control is high. Therefore, good followability can be obtained in the servo control.

As shown in FIG. 3, the width W_G of the guide member 30 is larger than the width W_T of the magnetic tape 12. In a case where the width W_G is the width W_T or less, end parts of the guide member 30 may damage both ends of the magnetic tape 12 in the width direction WD, or the magnetic tape 12 may have traces of the end parts of the guide member 30, but there is no such concern. In addition, the running stability of the magnetic tape 12 can be enhanced.

As shown in FIGS. 2 and 3, the slit 39 is formed in the sliding surface 38 along the width direction WD of the magnetic tape 12. A negative pressure is generated by the slit 39, and the magnetic tape 12 is drawn into the slit 39. Therefore, the displacement of the magnetic tape 12 in the width direction WD can be more effectively suppressed, and the running stability of the magnetic tape 12 can be further enhanced.

As shown in FIG. 1 and the like, the magnetic head is composed of the feed head 28 that operates in a case where the magnetic tape 12 is fed out from the cartridge reel 13 of the cartridge 11 in which the magnetic tape 12 is accommodated, and the rewind head 29 that operates in a case where the magnetic tape 12 is rewound on the cartridge reel 13. Therefore, data can be recorded and/or read by the magnetic head suitable for each of the case where the magnetic tape 12 is fed out and the case where the magnetic tape 12 is rewound.

As shown in FIG. 3, the feed head 28 takes charge of the first region divided with respect to the width direction WD of the magnetic tape 12, and the rewind head 29 takes charge of the second region divided with respect to the width direction WD of the magnetic tape 12. Therefore, it is possible to improve the efficiency of recording and/or reading data. In addition, in a case where the sizes of the first region and of the second region are the same as in this example, the feed head 28 and the rewind head 29 can have the same configuration, and various control methods, such as data recording control, need not be significantly changed.

As shown in FIGS. 3 and 4, the servo pattern 50 used for servo control to move the feed head 28 or the rewind head 29 in the width direction WD is recorded on the magnetic layer 16. The feed head 28 and the rewind head 29 each have the servo pattern reading element SR that reads the servo pattern 50, as the magnetic element. Therefore, the servo control to make the position of the feed head 28 or the rewind head 29 match the target position can be performed.

As shown in FIG. 3, in the magnetic layer 16, three servo bands SB on which the servo pattern 50 is recorded and two data bands DB on which data is recorded are alternately arranged along the width direction WD of the magnetic tape 12. The magnetic head is composed of the feed head 28 and the rewind head 29, and is provided as many as the number of data bands DB. Therefore, it is possible to further improve the efficiency of recording and/or reading data.

As shown in FIG. 4, the feed head 28 and the rewind head 29 each include two servo pattern reading elements SR corresponding to two servo bands SB that sandwich one data band DB and the data element DRW provided between two servo pattern reading elements SR, as the magnetic elements. Therefore, more accurate servo control based on the servo patterns 50 read by two servo pattern reading elements SR can be performed.

The data element DRW includes the data recording element DW that records data on the magnetic layer 16 and the data reading element DR that reads the data recorded on the magnetic layer 16. Therefore, data recording and data reading can be smoothly performed. The data element DRW may be any one of the data recording element DW or the data reading element DR.

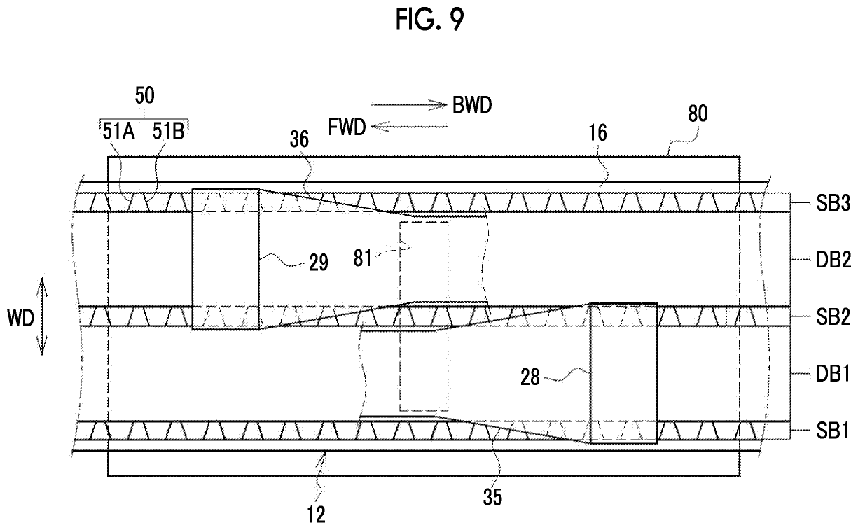

As in a guide member 80 shown in FIG. 9 as an example, a cavity 81 may be provided instead of the slit 39. The cavity 81 is formed in a central part of the guide member 80. The cavity 81 is a groove having a width smaller than that of the guide member 80. That is, the cavity 81 is an example of the “groove” according to the technology of the present disclosure, like the slit 39. Since the magnetic tape 12 is drawn in by the negative pressure even with the cavity 81, the running stability of the magnetic tape 12 can be further enhanced.

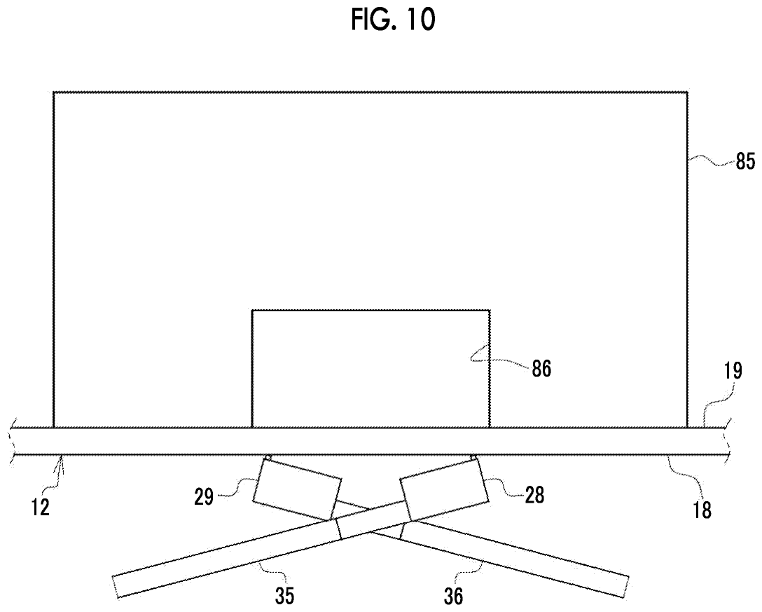

As shown in FIG. 10 as an example, the feed head 28 and the rewind head 29 may be disposed at positions facing a slit 86 of a guide member 85 via the magnetic tape 12. In this case, in the aspect in which the magnetic element, such as the data element DRW, is brought into contact with the magnetic layer 16, in a case where the feed head 28 and the rewind head 29 are moved by the servo control and apply a force to the magnetic tape 12, there is no probability of malfunction that the feed head 28 and the rewind head 29 are caught in the magnetic tape 12 because the magnetic tape 12 escapes to the inside of the slit 86.

The number of servo bands SB, the number of data bands DB, the number of data elements DRW, the number of data tracks DT that one data element DRW is in charge of, and the like shown above are merely an example, and the technology of the present disclosure is not particularly limited thereto.

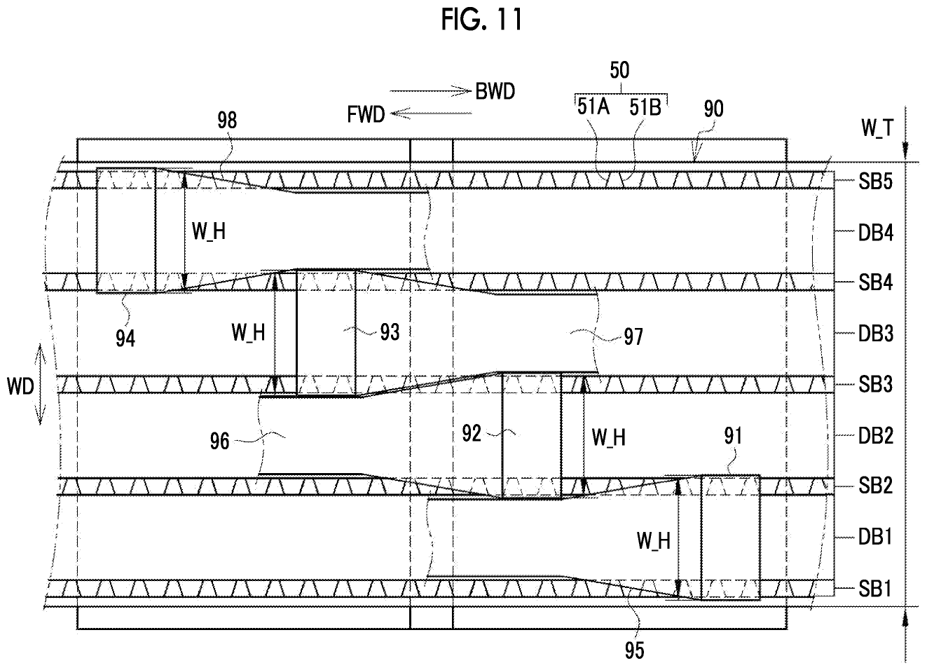

For example, as shown in FIG. 11, a magnetic tape 90 in which five servo bands SB1, SB2, SB3, SB4, and SB5 and four data bands DB1, DB2, DB3, and DB4 are alternately arranged along the width direction WD may be used. In this case, the magnetic head is composed of a first feed head 91 and a second feed head 92, and a first rewind head 93 and a second rewind head 94. The width W_H of each of these magnetic heads 91 to 94 is about ¼ of the width W_T of the magnetic tape 12. Suspensions 95, 96, 97, and 98 are connected to these magnetic heads 91 to 94, respectively. Further, the magnetic heads are disposed so as to be shifted from each other in the feed direction FWD and the rewind direction BWD such that these magnetic heads 91 to 94 do not interfere with each other.

The first feed head 91 records data on the data band DB1 and reads data recorded on the data band DB1. Further, the first feed head 91 reads the servo patterns 50 recorded on the servo bands SB1 and SB2. The second feed head 92 records data on the data band DB2 and reads data recorded on the data band DB2. Further, the second feed head 92 reads the servo patterns 50 recorded on the servo bands SB2 and SB3. In other words, the first feed head 91 and the second feed head 92 take charge of the first region divided with respect to the width direction WD of the magnetic tape 90. The first region in this case is the servo bands SB1 to SB3 and the data bands DB1 and DB2.

Meanwhile, the first rewind head 93 records data on the data band DB3 and reads data recorded on the data band DB3. Further, the first rewind head 93 reads the servo patterns 50 recorded on the servo bands SB3 and SB4. The second rewind head 94 records data on the data band DB4 and reads data recorded on the data band DB4. Further, the second rewind head 94 reads the servo patterns 50 recorded on the servo bands SB4 and SB5. In other words, the first rewind head 93 and the second rewind head 94 take charge of the second region divided with respect to the width direction WD of the magnetic tape 90. The second region in this case is the servo bands SB3 to SB5 and the data bands DB3 and DB4.

One feed head may record data on the data bands DB1 and DB2, read data recorded on the data bands DB1 and DB2, and read the servo patterns 50 recorded on the servo bands SB1 and SB2 or the servo bands SB2 and SB3. Similarly, one rewind head may record data on the data bands DB3 and DB4, read data recorded on the data bands DB3 and DB4, and read the servo patterns 50 recorded on the servo bands SB3 and SB4 or the servo bands SB4 and SB5.

Although not shown, a magnetic tape in which nine servo bands SB and eight data bands DB are alternately arranged along the width direction WD may be used. In this case, four feed heads and four rewind heads are provided. The width of each of the feed head and the rewind head is about ⅛ of the width of the magnetic tape. Alternatively, a magnetic tape in which 13 servo bands SB and 12 data bands DB are alternately arranged along the width direction WD may be used. In this case, six feed heads and six rewind heads are provided. The width of each of the feed head and the rewind head is about 1/12 of the width of the magnetic tape.

One magnetic head may be shared for feed/rewind without separating the feed head and the rewind head from each other. Further, the number of servo pattern reading elements SR disposed in one magnetic head may be one. Similarly, the number of data elements DRW disposed in one magnetic head may be one.

The number of data elements DRW disposed in one magnetic head may be, for example, 16, 32, or 64. Further, the number of data tracks DT that one data element DRW is in charge of for data recording and/or data reading is not limited to 12 illustrated above. The number of data tracks DT may be 1 or, for example, 4, 16, 32, or 64.

The magnetic tape device 10 in which the cartridge 11 is loaded has been illustrated, but the technology of the present disclosure is not limited thereto. The magnetic tape 12 as it is in which the cartridge 11 is not accommodated may be a magnetic tape device wound on a feed reel, that is, a magnetic tape device in which the magnetic tape 12 is irreplaceably installed.

The magnetic tape 12 is not limited to the magnetic tape having the magnetic layer 16 containing ferromagnetic powder illustrated above. A magnetic tape in which a ferromagnetic thin film is formed by vacuum deposition, such as sputtering, may be used.

The computer constituting the control unit 31 may include, for example, a programmable logic device (PLD) which is a processor whose circuit configuration is changeable after manufacture, such as a field-programmable gate array (FPGA), and/or a dedicated electrical circuit which is a processor having a dedicated circuit configuration designed to execute specific processing, such as an application specific integrated circuit (ASIC), in place of or in addition to the CPU.

The technology of the present disclosure can also appropriately combine the above-mentioned various embodiments and/or various modification examples. In addition, it goes without saying that the technology of the present disclosure is not limited to the above embodiments and various configurations may be employed without departing from the gist thereof.

The contents described and shown above are detailed descriptions of the parts related to the technology of the present disclosure, and are merely an example of the technology of the present disclosure. For example, the descriptions of the above configurations, functions, actions, and effects are the descriptions of an example of the configurations, functions, actions, and effects of the parts related to the technology of the present disclosure. Accordingly, it is needless to say that unnecessary parts may be deleted, new elements may be added, or replacements may be made with respect to the contents described and shown above, without departing from the gist of the technology of the present disclosure. Further, in order to avoid complications and facilitate understanding of the parts related to the technology of the present disclosure, descriptions of common general knowledge and the like that do not require special descriptions for enabling the implementation of the technology of the present disclosure are omitted, in the contents described and shown above.

In the present specification, “A and/or B” has the same meaning as “at least one of A or B”. That is, “A and/or B” means that only A may be used, only B may be used, or a combination of A and B may be used. In addition, in the present specification, the same concept as “A and/or B” is also applied to a case where three or more matters are expressed by “and/or”.

All documents, patent applications, and technical standards described in the present specification are incorporated in the present specification by reference to the same extent as in a case where the individual documents, patent applications, and technical standards were specifically and individually stated to be incorporated by reference.

What is claimed is:

1. A magnetic tape device comprising:
a magnetic head having a magnetic element that acts on a magnetic layer formed on a front surface of a magnetic tape; and
a guide member that is disposed at a position facing the magnetic head via the magnetic tape and guides the magnetic tape to the magnetic head,
wherein a back surface of the magnetic tape, which is provided on a side opposite to the front surface and is a surface coarser than the front surface, is slid on the guide member.

2. The magnetic tape device according to claim 1,
wherein a width of the magnetic head is smaller than a width of the magnetic tape.

3. The magnetic tape device according to claim 1,
wherein a width of the guide member is larger than a width of the magnetic tape.

4. The magnetic tape device according to claim 1,
wherein a sliding surface of the guide member on which the back surface is slid has a groove formed along a width direction of the magnetic tape.

5. The magnetic tape device according to claim 4,
wherein the magnetic head is disposed at a position facing the groove via the magnetic tape.

6. The magnetic tape device according to claim 1,
wherein the magnetic head includes
a feed head that operates in a case where the magnetic tape is fed out from a feed reel on which the magnetic tape is wound, and
a rewind head that operates in a case where the magnetic tape is rewound on the feed reel.

7. The magnetic tape device according to claim 6,
wherein the feed head takes charge of a first region divided with respect to a width direction of the magnetic tape, and
the rewind head takes charge of a second region divided with respect to the width direction.

8. The magnetic tape device according to claim 1,
wherein a servo pattern used for servo control to move the magnetic head in a width direction of the magnetic tape is recorded on the magnetic layer, and
the magnetic head has a servo pattern reading element that reads the servo pattern, as the magnetic element.

9. The magnetic tape device according to claim 8,
wherein a plurality of servo bands on which the servo pattern is recorded and a plurality of data bands on which data is recorded are alternately arranged in the magnetic layer along the width direction of the magnetic tape, and
the magnetic heads are provided as many as the number of data bands.

10. The magnetic tape device according to claim 9,
wherein the magnetic head has, as the magnetic element,
two servo pattern reading elements corresponding to two servo bands that sandwich one data band, and
a data element provided between two servo pattern reading elements.

11. The magnetic tape device according to claim 10,
wherein the data element includes
a data recording element that records the data on the magnetic layer, and
a data reading element that reads the data recorded on the magnetic layer.

12. A magnetic tape used in the magnetic tape device according to claim 1.

13. A method of operating a magnetic tape device, comprising:
sliding, on a guide member disposed at a position facing a magnetic head via a magnetic tape, a back surface of the magnetic tape provided on a side opposite to a front surface on which a magnetic layer is formed, the back surface being a surface coarser than the front surface; and
causing a magnetic element of the magnetic head to act on the magnetic layer of the magnetic tape guided by the guide member.
